(19) United States
(12) Patent Application Publication
(10) Pub. No.: US 2016/0131278 A1
(43) Pub. Date: May 12, 2016

(54) METHOD OF REHABILITATING EXISTING PIPE AND SUPPORT MEMBER FOR REHABILITATING PIPE

(71) Applicant: SEKISUI CHEMICAL CO., LTD., Osaka (JP)

(72) Inventors: Masahiro Yamasaki, Ritto-shi, Shiga (JP); Hiroki Senuma, Ritto-shi, Shiga (JP); Ryou Hosokawa, Ritto-shi, Shiga (JP); Yoshio Kaneko, Ritto-shi, Shiga (JP)

(21) Appl. No.: 14/895,690

(22) PCT Filed: Apr. 4, 2014
(86) PCT No.: PCT/JP2014/060020

§ 371 Date: Dec. 3, 2015

(30) Foreign Application Priority Data
Jun. 12, 2013 (JP) 2013-123898

(51) Int. Cl. F16L 1/00; F16L 55/165

(52) U.S. Cl. CPC F16L 1/00; F16L 55/1655

(57) ABSTRACT

There is provided a plurality of support members (1) in an existing pipe (101) to form a rehabilitating pipe (102). Each support member (1) includes an arcuate plate (2) that, with a substantially semicircular cross-section, has an inner diameter corresponding to the outer diameter of the rehabilitating pipe (102), so that the arcuate plate (2) is fixed to the upper half portion of the inner surface of the existing pipe (102). The rehabilitating pipe (102) is formed by spirally winding an elongate profile strip while pressing the side edges of the profile strip together from the inside thereof to join the side edges together so that the profile strip is in contact internally with the arcuate plate (2).

### TECHNICAL FIELD

The present invention relates to methods of rehabilitating existing pipes and also to support members used with the rehabilitating pipes in the rehabilitation method.

### BACKGROUND ART

Rehabilitation of old sewage pipes and other existing pipes by using rehabilitating pipes has been commonly known and practiced. A rehabilitating pipe is formed inside the existing pipe, for example, by spirally winding a profile strip that has a joining portion on each side edge and joining the adjacently placed joining portions of the profile strip together. After the winding, mortar or a like back-filling material is injected into a gap between the rehabilitating and existing pipes to integrate the pipes together.

The injection of a back-filling material into a gap between the existing and rehabilitating pipes produces buoyant force acting on the rehabilitating pipe in accordance with the volume of the internal hollow space of the rehabilitating pipe and the density of the back-filling material. The buoyant force grows with the diameter of the rehabilitating pipe. The buoyant force lifts up the rehabilitating pipe so that the rehabilitating pipe may be pressed against the inner surface of the existing pipe and deformed elliptically in its otherwise circular cross-section. If the rehabilitating pipe is deformed elliptically, the drain gradient of the pipe changes, thereby lowering its drain capability, and its structural integrity is unfavorably reduced. Accordingly, the deformation of the rehabilitating pipe needs to be prevented by installing a plurality of prop devices (for example, those disclosed in Patent Documents 1 and 2) at intervals inside the rehabilitating pipe.

As illustrated in FIG. 18, these kinds of prop devices are fixed to the interior of the rehabilitating pipe 102 and have a plurality of prop members 111 that supports the rehabilitating pipe 102. A plurality of prop devices 110 is installed in the rehabilitating pipe 102 at intervals along the axis of the rehabilitating pipe 102. The prop devices, installed in this manner, prevent the rehabilitating pipe 102 from buckling or otherwise deforming upon the injection of the back-filling material 104 and also prevent the rehabilitating pipe 102 from being lifted up inside the existing pipe 101.

Still referring to the figure, columnar prop members 111 are installed vertically in the rehabilitating pipe 102. The through holes in which the prop members 111 are attached are formed through the top portion of the rehabilitating pipe 102. After filling the gap between the existing pipe 101 and the rehabilitating pipe 102 with the back-filling material 104, the prop devices 110 being installed in place are all disassembled and removed. Removing the prop members 111 from the rehabilitating pipe 102 leaves, in the top portion of the inner surface of the rehabilitating pipe 102, concavities (prop holes) from which the prop members 111 have been pulled out. These concavities need to be sealed and closed.

Patent Document 3 proposes spacers being installed on the top portion of the existing pipe along the entire length of the existing pipe, so as to enable the injection of a back-filling material into a gap between the existing pipe and the rehabilitating pipe through the clearance formed by the spacers.

### CITATION LIST

### Patent Literature

Patent Document 1: JP 2898195

Patent Document 2: JP 10-121565 A

Patent Document 3: JP 7-100925 A

### SUMMARY OF THE INVENTION

### Problems to be Solved by the Invention

As described above, the conventional prop device requires much time and labor to install and later remove the numerous prop members, as well as to open through holes in the rehabilitating pipe and seal and close the concavities from which the prop members have been pulled out. These requirements present huge obstacles in shortening the construction period.

With prop devices installed in the rehabilitating pipe, the water flow in the pipe meets increased resistance, a factor that contributes to rising water levels. Therefore, in an environment where the water levels are already high, the installation of the prop devices further increases the water levels, which may hamper the rehabilitation work. Workers must evacuate the pipe when rapid water level increases are expected, for example, due to sudden heavy rainfalls. The prop devices installed in the pipe could hinder quick evacuation.

The spacers disclosed in Patent Document 3 are intended to ensure the provision of injection paths for back-filling material. The rehabilitating pipe is pressed by the spacers inside the existing pipe; the cross-section of the rehabilitating pipe is not circular, but elliptically deformed. In addition, the spacers are fixed by driving anchor bolts into the existing pipe. However, old existing pipes may have a decreased thickness, for example, due to corrosion to such an extent that the spacers cannot be tightly fixed. The anchor bolts may not be driven into the existing pipe if the existing pipe contains reinforcing steel rods. Even when it is possible to fix the spacers using anchor bolts, the fixing work still requires an extended period of time, leading to a low efficiency.

In view of these problems, it is an object of the present invention to provide a method of rehabilitating an existing pipe, as well as a support member for a rehabilitating pipe, that (1) prevent the rehabilitating pipe from being deformed or lifted up due to buoyant force acting on the rehabilitating pipe upon injection of a back-filling material, (2) impart sufficiently structural integrity and drain capability to the rehabilitated pipe line by maintaining the cross-section of the rehabilitating pipe formed inside the existing pipe in a proper, circular shape, and (3) facilitate quick and efficient work.

### Solution to Problem

The solution to the problems that is provided by the present invention to achieve the aforementioned object is based on a method of rehabilitating an existing pipe that is performed by forming a rehabilitating pipe in the existing pipe. This particular rehabilitation method includes the steps of: installing a plurality of support members in the existing pipe, each of the plurality of support members including an arcuate plate that has an inner diameter corresponding to an outer diameter of the rehabilitating pipe; disposing the arcuate plates at least on an upper half portion of an inner surface of the existing pipe to fix the plurality of support members; spirally winding an elongate profile strip and guiding a side edge of the profile strip internally relative to a preceding side edge of the profile strip so as to form the rehabilitating pipe in contact internally with the arcuate plates by joining the side edges together; and causing the arcuate plates to support at least right and left parts of an outer surface of the rehabilitating pipe as viewed from an axial direction of the rehabilitating pipe and filling a gap between the rehabilitating pipe and the existing pipe with a back-filling material.

These specific features prevent the rehabilitating pipe from being deformed or lifted up even though the injection of the back-filling material between the existing pipe and the rehabilitating pipe produces buoyant force acting on the rehabilitating pipe, because the support members support the outer surface of the rehabilitating pipe. The features hence maintain the cross-section of the rehabilitating pipe in a proper, circular shape throughout from the injection to the curing of the back-filling material, thereby forming a rehabilitated pipe line with high structural integrity. In addition, after the rehabilitation work is completed, the support members do not need to be removed from the existing pipe and may be left attached to the rehabilitating pipe and buried together. Therefore, the rehabilitation work is performed efficiently, the construction period shortened, and the rigidity of the rehabilitating pipe increased.

The method of rehabilitating an existing pipe described above is preferably such that the plurality of support members are installed along an axis of the existing pipe at specified intervals.

The plurality of support members are preferably installed in the existing pipe prior to the rehabilitating pipe being formed.

The back-filling material is preferably injected and cured in phases, first in a lower part, then in a middle part, and subsequently in an upper part of the gap between the rehabilitating pipe and the existing pipe.

A support member for a rehabilitating pipe used in the method of rehabilitating an existing pipe described above to achieve the aforementioned object falls within the range of the technical concept of the present invention.

Specifically, the support member for a rehabilitating pipe includes: an arcuate plate that has an inner diameter corresponding to an outer diameter of the rehabilitating pipe and an arc length greater than or equal to half an outer circumference of the rehabilitating pipe; and a plurality of projections provided on an outer surface of the arcuate plate and extending in an axial direction, wherein: the plurality of projections are disposed at least on right- and left-hand sides when viewed from the axial direction and at intervals that are measured along the arc length of the arcuate plate; the rehabilitating pipe is formed in an existing pipe by spirally winding an elongate profile strip and joining a side edge of the profile strip internally to a preceding side edge of the profile strip; and the arcuate plate is fixed to an upper half portion of the existing pipe and supports an upper half portion of the rehabilitating pipe in such a manner as to maintain an inner surface of the existing pipe at a fixed distance from an outer surface of the rehabilitating pipe.

These specific features prevent the rehabilitating pipe from being deformed or lifted up even though the injection of the back-filling material between the existing pipe and the rehabilitating pipe produces buoyant force acting on the rehabilitating pipe, because the support members support the outer surface of the rehabilitating pipe. The projections on the support members maintain the inner surface of the existing pipe at a fixed distance from the outer surface of the rehabilitating pipe, thereby maintaining a gap into which the back-filling material is injected. In addition, the support members can be installed extremely easily and fixed stably to the inner surface of any existing pipe. The installation work is thus efficient and shortens the construction period.

The support member for a rehabilitating pipe may be configured more specifically as in the following examples.

Each of the plurality of projections preferably includes: a radial rib that defines the fixed distance; and a contact section provided on a distal end of the radial rib in contact with the inner surface of the existing pipe. These features enhance the use of common components for the projections and enable modifications, such as the adjustment of the height of the radial rib and the alteration of the shape of the contact section, to be carried out in accordance with the outer diameter, position, and other conditions of the rehabilitating pipe.

The support member is preferably such that the plurality of projections are separable from the arcuate plate so that the support member can be assembled by coupling a required number of projections to the arcuate plate. When this is the case, the support member may be formed by coupling the projections to the arcuate plate in advance. Alternatively, the support member may be formed by coupling the projections to the arcuate plate only after the arcuate plate is placed on the upper half portion near the leading end of the rehabilitating pipe that is already formed.

Each of the plurality of projections may have an adjusting member that adjusts a gap between the inner surface of the existing pipe and the outer surface of the arcuate plate. The use of such a gap adjusting member enables efficient rehabilitation of the existing pipe, for example, when the inner surface of the existing pipe is so corroded that its thickness has decreased.

The arcuate plate preferably includes an adjusting member, provided on a side rim thereof, that adjusts an arc length of the support member. These features enable more stable installation of the support member in the existing pipe through the adjustment of the length of the adjusting member.

The support member may have an outer diameter corresponding to an inner diameter of the existing pipe and include a band that has an arc length equal to that of a lower half portion of the existing pipe, the band preferably being coupled to a side rim of the arcuate plate so as to render the arc length of the band adjustable. Through the adjustment of the arc length of the band, these features also enable more stable installation of the support member in the existing pipe.

The arcuate plate may be composed of multiple pieces, one corresponding to a top portion of the rehabilitating pipe and others corresponding to side portions of the rehabilitating pipe, the piece corresponding to the side portions preferably being coupled freely pivotally to the piece corresponding to the top portion and so as to be capable of being fixed in any pivotal position.

These features enable the piece corresponding to the side portion to be fixed slightly upward with respect to the piece corresponding to the top portion and hence installed, elastically deformed, to the upper half portion of the existing pipe. The restoring force produced by the elastic deformation of the piece corresponding to the side portion presses the inner surface of the existing pipe, thereby fixing the support member in a stable manner.

In the present invention, the support member is installed on an upper half portion of the existing pipe or the rehabilitating pipe. The arcuate plate is in contact with at least the upper half portion of the rehabilitating pipe and is supported by the existing pipe via the projections, thereby maintaining the distance from the inner curved surface of the existing pipe. Accordingly, the rehabilitating pipe is not deformed or lifted up even though the injection of the back-filling material produces buoyant force acting on the rehabilitating pipe, because the support member supports the rehabilitating pipe by squeezing the rehabilitating pipe on the right and left parts of the outer surface thereof when viewed from the axial direction. The cross-section of the rehabilitating pipe is maintained in a proper, circular shape.

### Advantageous Effects of the Invention

According to the method of rehabilitating an existing pipe in accordance with the present invention, quick and efficient rehabilitation work can be performed on any existing pipe, and the construction period for the whole project is greatly shortened. Furthermore, the rehabilitated pipe line is given sufficient structural integrity and drain capability.

According to the support member for a rehabilitating pipe in accordance with the present invention, the rehabilitating pipe is prevented from being lifted up or deformed by the buoyant force acting on the rehabilitating pipe, which enables rehabilitation work while maintaining a proper cross-sectional shape. In addition, the support member can be installed quickly by an extremely simple process and does not need to be removed, which greatly shortens the construction period.

### BRIEF DESCRIPTION OF DRAWINGS

FIG. 1 is a perspective view of a support member for a rehabilitating pipe in accordance with embodiment 1 of the present invention.

FIG. 2, showing a step of a method of rehabilitating an existing pipe using this support member, is a frontal cross-sectional view of the rehabilitating pipe.

FIG. 3, showing another step of the same method, is a sideways cross-sectional view of the rehabilitating pipe.

FIG. 4 is a cross-sectional view of an existing pipe rehabilitated by the method.

FIG. 5 is an illustration of a process in which a back-filling material is injected according to the method.

FIG. 6 is a graph comparing the rehabilitation method of the present invention and the conventional rehabilitation method in terms of the number of days needed to complete the rehabilitation work.

FIGS. 7(a) and 7(b) show a variation example of the support member in accordance with embodiment 1, FIG. 7(a) being a perspective view of the support member and FIG. 7(b) illustrating how the support member is coupled.

FIGS. 8(a) and 8(b) show a support member in accordance with embodiment 2, FIG. 8(a) being a perspective view of the support member and FIG. 8(b) being a partially enlarged view for Section A in FIG. 8(a).

FIGS. 9(a) to 9(c) are illustrations of the steps of a method of rehabilitating an existing pipe using the support member shown in FIG. 8.

FIGS. 10(a) to 10(c) show a support member in accordance with embodiment 3, FIG. 10(a) being a perspective view of the support member, FIG. 10(b) being a partially enlarged view for Section B in FIG. 10(a), and FIG. 10(c) being a partially enlarged view for Section C in FIG. 10(a).

FIGS. 11(a) and 11(b) show a variation example of the support member in accordance with embodiment 3, FIG. 11(a) being a perspective view of the support member and FIG. 11(b) being a side view of the support member.

FIGS. 12(a) and 12(b) show a support member in accordance with embodiment 4, FIG. 12(a) being a perspective view of the support member and FIG. 12(b) being a partially enlarged view for Section D in FIG. 12(a).

FIG. 13 is a perspective view of a support member in accordance with embodiment 5.

FIG. 14 is a perspective view of a support member in accordance with another embodiment.

FIG. 15 is a cross-sectional view of a method of rehabilitating an existing pipe using the support member shown in FIG. 14.

FIG. 16 is a cross-sectional view of a support member and a method of rehabilitating an existing pipe in accordance with a further embodiment.

FIG. 17 is a front view of an exemplary winding machine used in a method of rehabilitating an existing pipe of the present invention.

FIG. 18 is a front view of an exemplary prop device used in a conventional method of rehabilitating an existing pipe.

### DESCRIPTION OF EMBODIMENTS

Referring to drawings, the following will describe methods of rehabilitating an existing pipe and support members for a rehabilitating pipe in accordance with the present invention.

### Embodiment 1

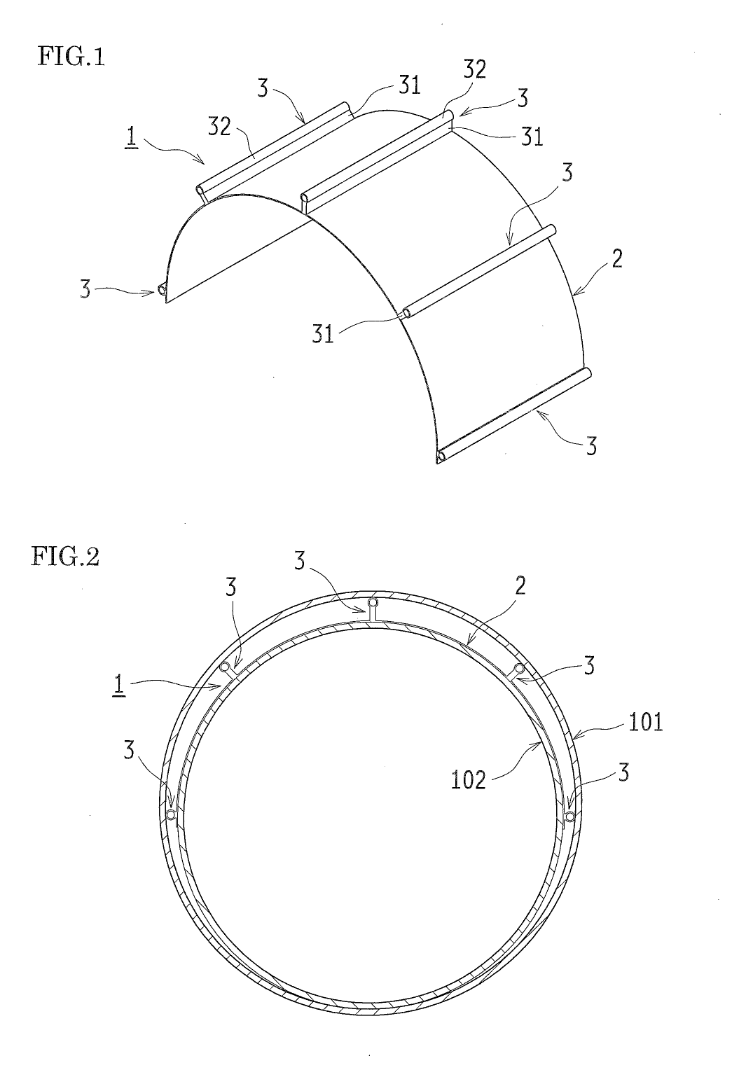

A support member 1 for a rehabilitating pipe includes an arcuate plate 2 and projections 3 provided on the outer surface of the arcuate plate 2. As illustrated in FIG. 1, the arcuate plate 2 is formed so as to have a substantially semicircular cross-section that has a higher curvature than the inner surface of the existing pipe 101. The arcuate plate 2 is made of steel or a like material and has an inner diameter corresponding to the outer diameter of the rehabilitating pipe 102 and an arc length greater than or equal to half the outer circumference of the rehabilitating pipe 102. The arcuate plate 2 of the support member 1 is disposed on the upper half portion of the inner surface of the existing pipe 101.

The projections 3 are disposed on the outer surface of the arcuate plate 2 and extend in an axial direction, The projections 3 are disposed at least on the right- and left-hand sides when viewed from the axial direction and at intervals that are measured along the arc length of the arcuate plate 2. In other words, the projections 3 are located at least at the three and nine o'clock positions on the outer circumference of the rehabilitating pipe 102.

In the embodiment, as illustrated in FIG. 2, the projections 3 are provided substantially at the three, half-past-one, twelve, half-past-ten, and nine o'clock positions, with the twelve o'clock position being the top portion of the substantially circular outer surface of the rehabilitating pipe 102, when viewed from the axial direction of the rehabilitating pipe 102. The projections 3 are disposed at equally distanced, right/left symmetric positions when the substantially circular cross-section of the rehabilitating pipe 102 is viewed from the front.

Each projection 3 has a thin, elongate radial rib 31 and a contact section 32. The contact section 32 is provided on the distal end of the radial rib 31 and extends along the length of the rib 31. The radial rib 31, made from an elongate steel plate or a like member, is provided radially around the axial center of the rehabilitating pipe 102. The radial ribs 31 have heights specified based on either the inner diameter of the existing pipe 101 and the outer diameter of the rehabilitating pipe 102 or the relative positions of the radial ribs 31 on the arcuate plate 2. The contact section 32 comes into contact with the inner surface of the existing pipe 101 and is made of, for example, a steel pipe or bar with a circular or rectangular cross-section.

The support member 1 supports the upper half portion of the rehabilitating pipe 102 because the arcuate plate 2 is fixed to the upper half portion of the existing pipe 101. The arcuate plate 2 is supported by the inner surface of the existing pipe 101 via the projections 3. Especially via those projections 3 which are disposed at the three and nine o'clock positions is the arcuate plate 2 fixed to the upper half portion of the inner surface of the existing pipe 101. Accordingly, the support member 1 serves to maintain the inner surface of the existing pipe 101 at a fixed distance from the outer surface of the rehabilitating pipe 102.

Next will be described a method of rehabilitating the existing pipe 101 using the support member 1.

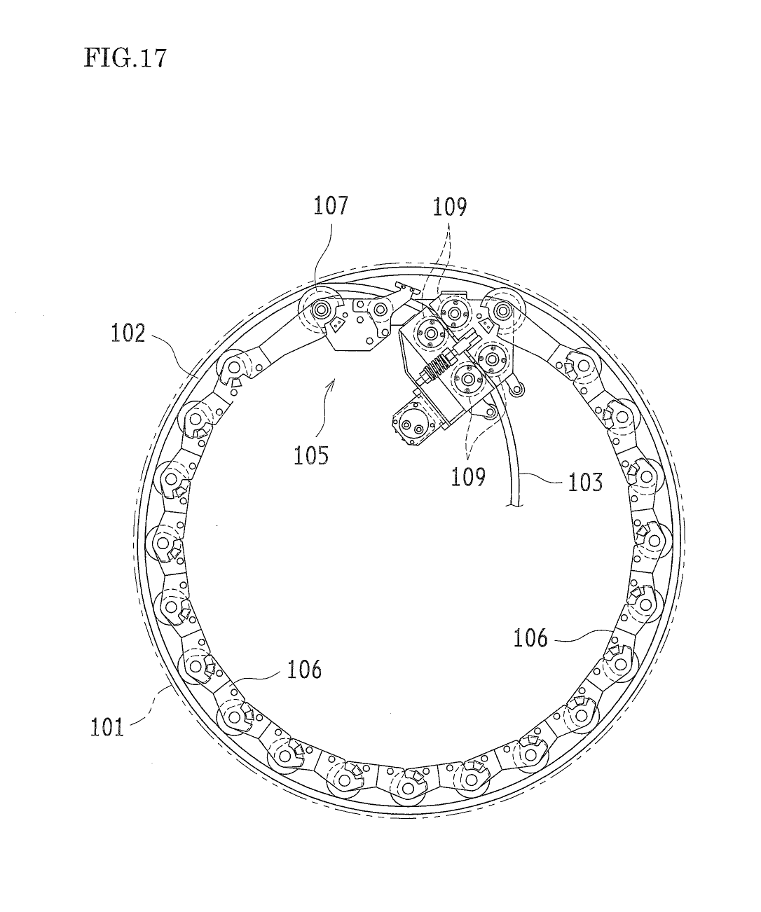

The rehabilitating pipe 102 is formed inside the existing pipe 101 by using a winding machine 105, an example of which is shown in FIG. 17. The winding machine 105 includes mutually coupled linking bodies 106, a roller 107 that joins the side edges of the profile strip 103 together, and a pinch roller 109 that supplies the profile strip 103 internally to the roller 107. The winding machine 105 spirally winds the elongate profile strip 103. In this winding process, a side edge of the profile strip 103 is guided internally relative to a preceding side edge of the profile strip 103 so that a joining portion of the profile strip 103 is fitted internally to a preceding joining portion of the profile strip 103. The profile strip 103 is processed in this manner to form a pipe progressively.

The profile strip 103 has attached thereto a reinforcing metal member continuously along the length thereof. The reinforcing member is, for example, formed by bending a thin, elongate steel plate so that its cross-section has a substantially W-like shape and inserted between the ribs of the profile strip 103. This structure adds to the structural integrity and rigidity of the rehabilitating pipe 102 formed.

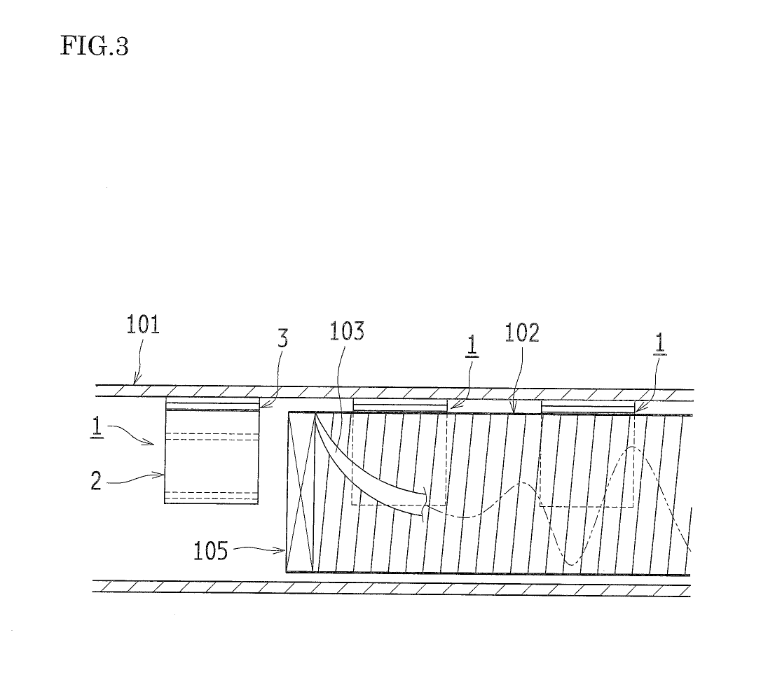

The existing pipe 101 may be rehabilitated in the following manner. First, a plurality of support members 1 is installed inside the existing pipe 101. The support members 1 are installed at specified intervals that are measured in the axial direction of the existing pipe 101 as illustrated in FIG. 3.

The interval by which each support member 1 is separated from adjacent ones can vary depending on the diameter of the rehabilitating pipe 102 and may be set, for example, to 500 mm if the arcuate plate 2 of the support member 1 has a length of 500 mm in the axial direction. In other words, the support members 1 are installed, one for every meter that is measured out in the axial direction of the rehabilitating pipe 102.

This structure provides such an effective arrangement of the support members 1 that the time and labor required for the installation of the support members 1 are reduced. In addition, since the support members 1 are disposed at equal distances in the axial direction, the rehabilitating pipe 102 is prevented from expanding out of the space between the adjacent support members 1 or otherwise being deformed when a back-filling material 104 is injected.

Next, the winding machine 105 is assembled in the existing pipe 101. The profile strip 103 is drawn into the existing pipe 101 and fed to the winding machine 105, after which the winding machine 105 is turned on. The winding machine 105 revolves around the axial center of the existing pipe 101 to wind the profile strip 103 spirally so that the adjacently positioned joining portions of the profile strip 103 are joined together to form the rehabilitating pipe 102 in contact internally with the arcuate plates 2 of the support members 1. A succeeding stretch of the profile strip 103 is continuously fed to the leading end of the rehabilitating pipe 102 to form an additional stretch of the rehabilitating pipe 102.

The rehabilitating pipe 102 is left to sit inside the existing pipe 101 without being rotated. The support members 1 therefore experience no frictional resistance on the outer surface of the rehabilitating pipe 102 and are not moved out of place. Referring to FIG. 2, the support members 1 are fixed inside the existing pipe 101 so as to be positioned atop the upper half portion of the rehabilitating pipe 102 in a stable manner. The rehabilitating pipe 102 is formed with the upper half portion thereof being in contact internally with the arcuate plates 2, so as to be supported by the support members 1.

Since the support members 1 are installed on the upper half portion of the existing pipe 101, the arcuate plates 2 are in contact with the upper half portion of the rehabilitating pipe 102 along at least half the circumference of the rehabilitating pipe 102. The rehabilitating pipe 102 is supported by the support members 1 inside the existing pipe 101 so that it can be positioned at a fixed distance from the inner surface of the existing pipe 101.

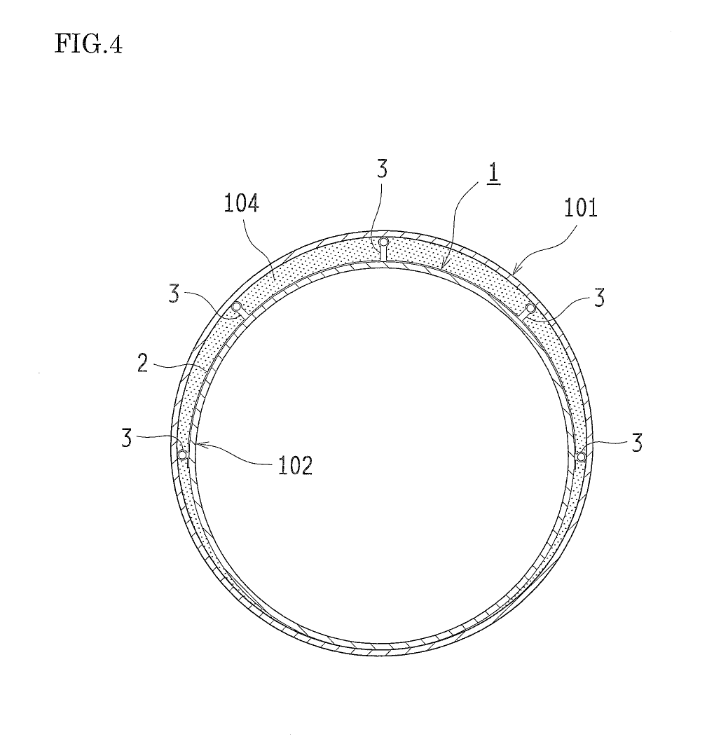

In this manner, the rehabilitating pipe 102 is formed along the entire length of the segment of the existing pipe 101 to be rehabilitated. Subsequent to the formation of the rehabilitating pipe 102, both ends of that segment are closed. Then, mortar or a like back-filling material 104 is injected into a gap between the inner surface of the existing pipe 101 and the outer surface of the rehabilitating pipe 102 to fill the gap as illustrated in FIG. 4. As the back-filling material 104 cures, the existing pipe 101 and the rehabilitating pipe 102 are integrated, thereby rehabilitating the existing pipe 101.

When the back-filling material 104 is injected, the rehabilitating pipe 102 receives buoyant force that could lift up the rehabilitating pipe 102 inside the existing pipe 101. The rehabilitating pipe 102, however, is supported stably by the arcuate plates 2 that straddle the arcuate plates 2. The rehabilitating pipe 102 therefore will not be lifted, thereby maintaining the gap below the existing pipe 101 as it is prior to the injection of the back-filling material 104.

Besides, as illustrated in FIG. 2, the rehabilitating pipe 102 is in contact with the arcuate plates 2 of the support members 1 along approximately at least half the outer circumference thereof. The arcuate plates 2 are supported by the upper half portion of the rehabilitating pipe 102 via the projections 3. The arcuate plates 2 are disposed so that the arcuate plates 2 flank the rehabilitating pipe 102 on the right and left parts of the outer surface thereof (the approximately three and nine o'clock parts of the surface) when the rehabilitating pipe 102 is viewed from the axial direction thereof.

Therefore, the back-filling material 104 can be injected into, and thereby fill, the gap while maintaining the shape of the rehabilitating pipe 102 as illustrated in FIG. 4. Hence, the rehabilitating pipe 102 can be formed with a proper, circular cross-section. The rehabilitating pipe 102 with a proper cross-sectional shape very preferably exhibits high structural integrity and superior durability.

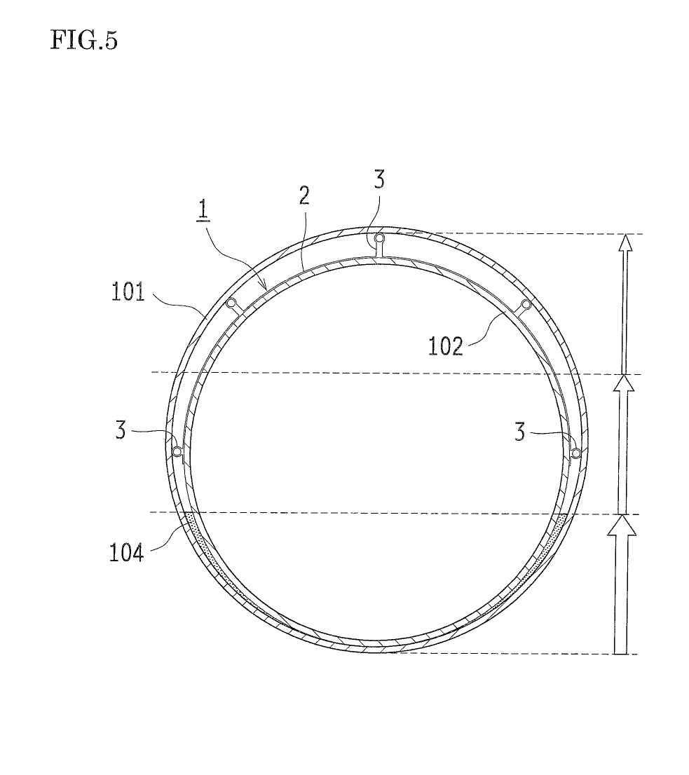

The back-filling material 104 may be injected and cured in phases, first in the lower part, then in the middle part, and subsequently in the upper part of the gap between the rehabilitating pipe 102 and the existing pipe 101 as illustrated in FIG. 5. As the back-filling material 104 injected into the lower part cures, the lower part of the rehabilitating pipe 102 is fixed onto the existing pipe 101 whereas the upper half portion of the rehabilitating pipe 102 is straddled and supported by the support members 1 with the proper cross-sectional shape thereof being maintained. Thereafter, the back-filling material 104 injected into the middle part adds further stability to the fixing of the rehabilitating pipe 102. This structure is sufficiently capable of resisting the buoyant force acting on the rehabilitating pipe 102. The back-filling material 104 can be hence injected while maintaining the cross-section of the rehabilitating pipe 102 in a proper, circular shape.

The support members 1 do not need to be removed after the curing of the back-filling material 104 and may be left installed inside the existing pipe 101. The back-filling material 104 cures with the support members 1 supporting the rehabilitating pipe 102 in a stable manner. The support members 1 are hence integrated with the upper half portion of the rehabilitating pipe 102. The arcuate plates 2 of the support members 1, having being integrally fixed to the outer surface of the rehabilitating pipe 102, adds to the rigidity of the rehabilitating pipe 102 and forms a pipe line with sufficient structural integrity.

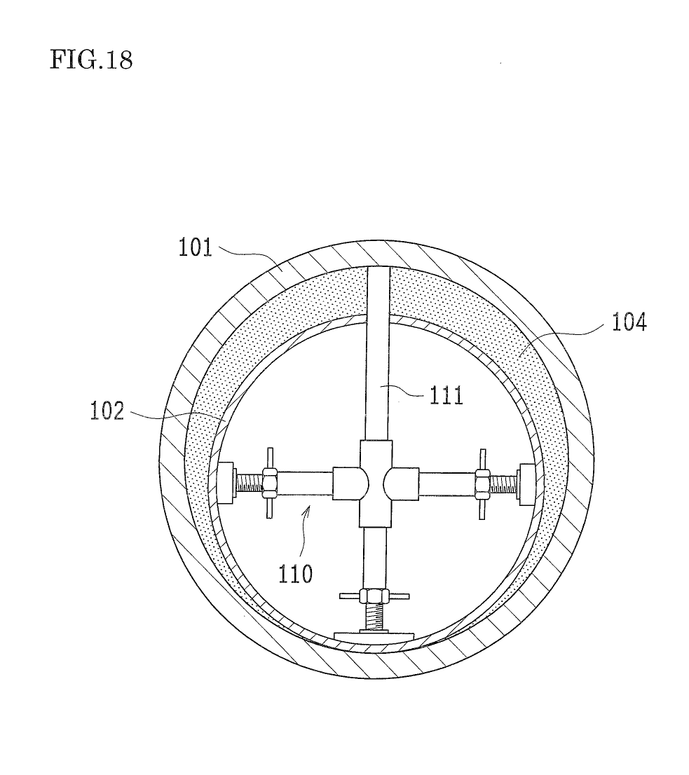

During the rehabilitation of the existing pipe 101, there exist no conventional prop devices (see FIG. 18) or other like obstacles in the rehabilitating pipe 102. That eliminates a factor that contributes to rising water levels in the existing pipe 101, which means fewer constraints encountered in construction work. Since there is hence provided an obstacle-free passageway in the existing pipe 101, workers can quickly evacuate the existing pipe 101 when abrupt water level increases are expected.

The support members 1 do not require laborious jobs like driving anchor bolts into the existing pipe 101. Therefore, the support members 1 can be fixed extremely easily and stably. The inner surface of the existing pipe 101 may have been damaged or have a decreased thickness due to corrosion or for other reasons; the support members 1 can be, however, installed reliably and efficiently on any type of inner surface of the existing pipe 101.

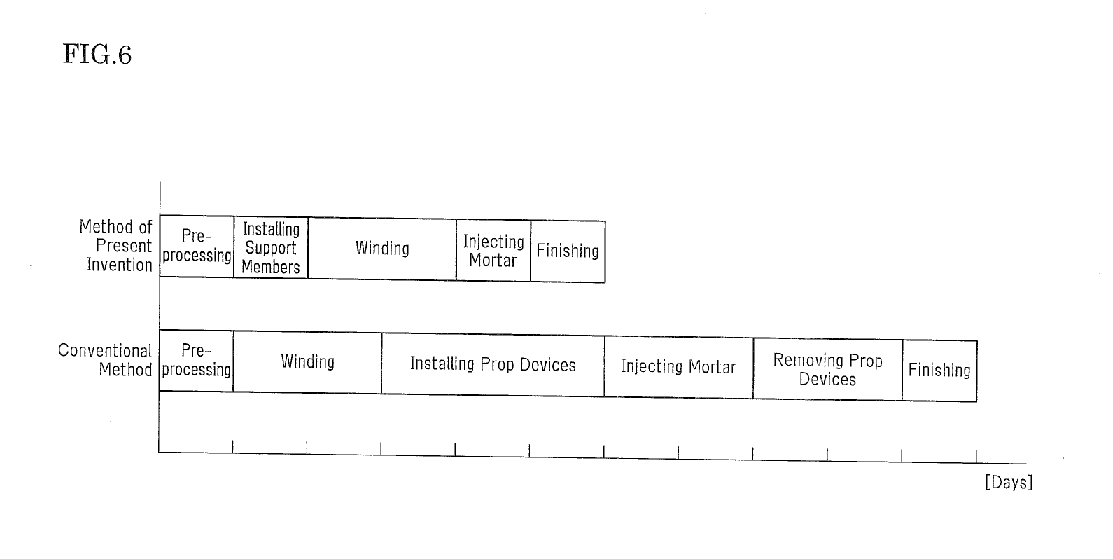

The aforementioned method of rehabilitating an existing pipe is capable of shortening the construction period when compared with conventional rehabilitation methods as represented in FIG. 6. The support members 1 can be installed in the existing pipe 101 by an extremely simple process and hence quickly before forming the rehabilitating pipe 102. In addition, since the support members 1 are stably supporting the rehabilitating pipe 102 when the back-filling material 104 is injected, the injection and filling require less time and labor and can be performed efficiently. After the curing of the back-filling material 104, the aforementioned method does not require the removal of the support members 1 and allows skipping related work; the curing may be followed immediately by finishing. The method greatly reduces work as demonstrated above and hence requires fewer workers.

Meanwhile, according to the conventional method, the prop devices need to be installed after the rehabilitating pipe 102 is formed. The conventional method therefore needs time and labor. During the subsequent injection of the back-filling material 104, there exist prop devices in the rehabilitating pipe 102; the devices may hamper the speeding of the work, and workers will need to work carefully while paying attention to possible deformation and lifting of the rehabilitating pipe 102. The curing of the back-filling material 104 should be followed not only by the removal of the prop devices 110 shown in FIG. 18, but also by the sealing of the concavities from which the prop members 111 have been pulled out, which is both labor- and time-consuming.

The rehabilitation method of the present invention obviates the need for all these laborious jobs, thereby drastically reducing the time needed for each job in the rehabilitation of the existing pipe 101 and greatly shortening the construction period as represented in FIG. 6.

When the rehabilitating pipe 102 is being formed, the workers may be ahead of the rehabilitating pipe 102 so that they can install the support members 1 simultaneously with the formation of the rehabilitating pipe 102. In addition, the arcuate plates 2 may be installed contiguously with zero intervening distance between them, as well as the support members 1 are installed at intervals along the axis of the rehabilitating pipe 102.

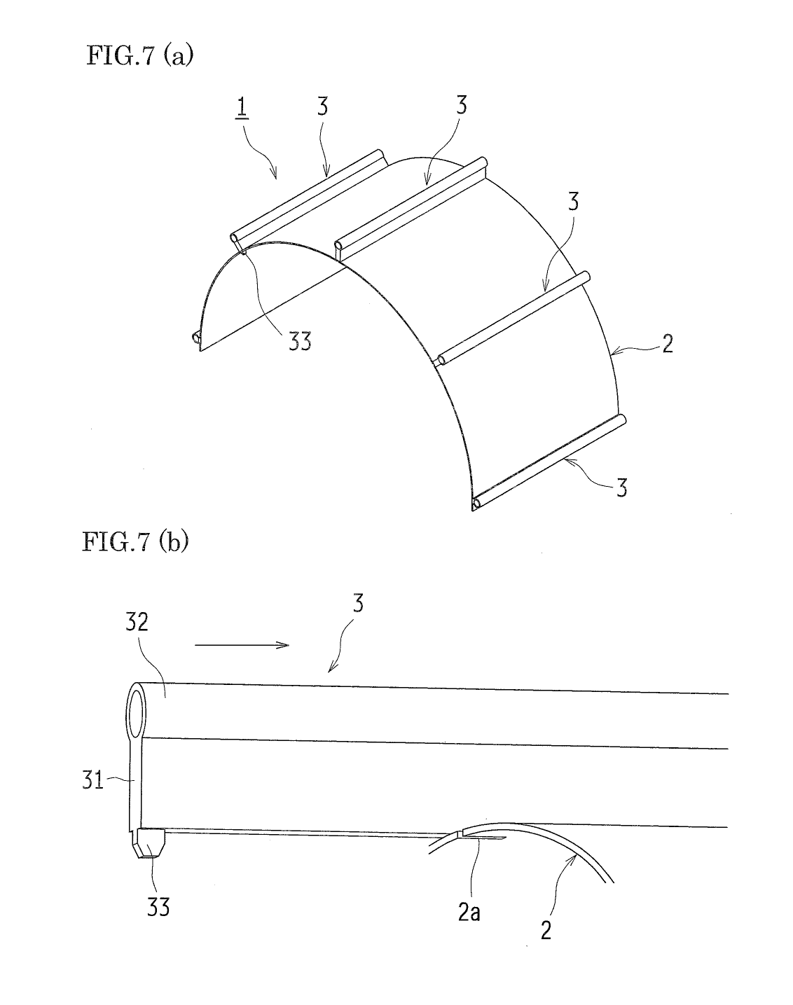

FIGS. 7(a) and 7(b) show a variation example of the support member 1 in accordance with embodiment 1.

This support member 1 is not pre-formed in the same shape as the support member 1 shown in FIG. 1 and may be assembled in a suitable manner before being installed in the existing pipe 101. The support member 1 can be assembled by coupling a plurality of projections 3 to an arcuate plate 2.

For example, referring to FIG. 7(b), the projections 3 of the support member 1 each have a radial rib 31 that has a coupling portion 33 on the bottom thereof. The arcuate plate 2 has formed therein a notch 2a to which the coupling portion 33 is fitted.

The projection 3 is coupled to the arcuate plate 2 by inserting the coupling portion 33 into a proper one of the notches 2a in the outer surface of the arcuate plate 2. In this manner, the support-member 1 can be easily assembled. Conversely, the support member 1 can be readily disassembled into the arcuate plate 2 and the projection(s) 3. The number of projections 3 may be increased or decreased, and their layout may be changed, depending on the distance between the outer surface of the rehabilitating pipe 102 and the inner surface of the existing pipe 101. Similarly to embodiment 1, the support member 1 can be installed stably in the existing pipe 101 by such a simple process that the rehabilitation work can be performed in a short time.

The coupling portion 33 and the notch 2a are preferably provided in consideration of the lead angle of the profile strip 103 so that the coupling portion 33 and the notch 2a are positioned between the ribs of the profile strip 103 from which the rehabilitating pipe 102 is formed.

### Embodiment 2

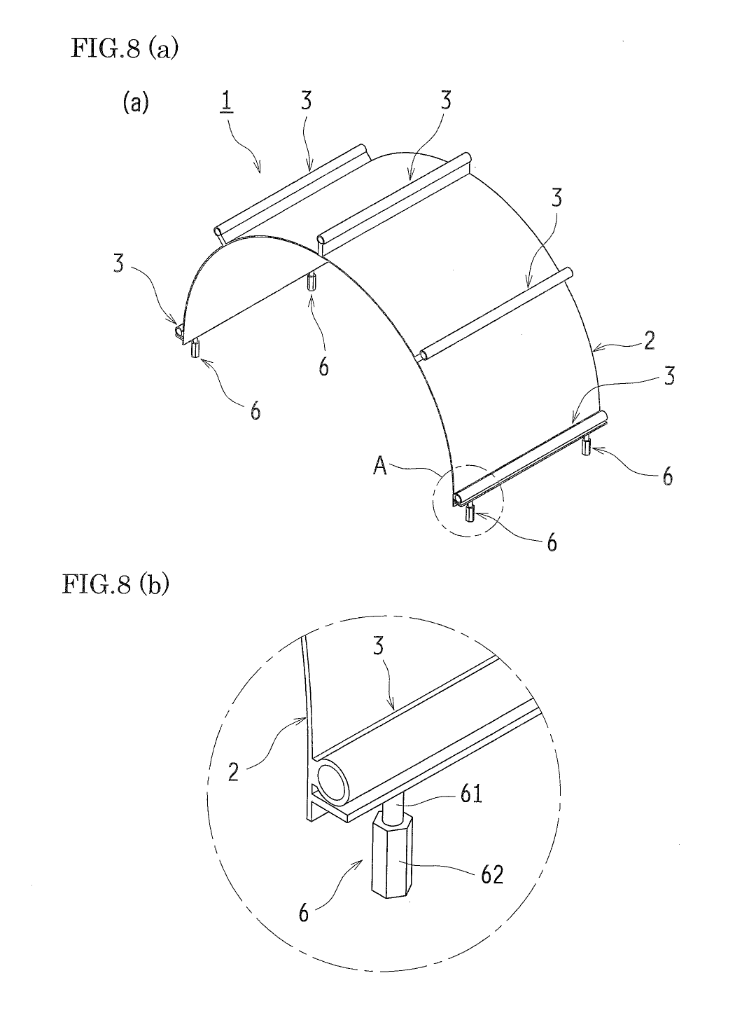

FIGS. 8(a) and 8(b) show a support member 1 in accordance with embodiment 2.

As illustrated in FIGS. 8(a) and 8(b), the support member 1 further includes length adjusting members 6 disposed in a balanced manner on both side rims of the arcuate plate 2 of the support member 1. Each length adjusting member 6 is formed by screwing a long nut 62 to a bolt 61 that is welded to one of the side rims of the arcuate plate 2. The adjusting members 6 are disposed at those positions which correspond to the right and left parts of the outer surface of the rehabilitating pipe 102 when viewed from the axial direction of the rehabilitating pipe 102.

To install the support member 1 in the existing pipe 101, the support member 1 is held close to the existing pipe 101 so that the contact section 32 on the top portion (at the twelve o'clock position) of the arcuate plate 2 faces the top portion of the existing pipe 101. In this condition, the long nuts 62 are loosened around the bolts 61 of the length adjusting members 6. This operation brings the bottoms of the long nuts 62 into contact with the inner surface of the lower half portion of the existing pipe 101, causing the support member 1 to be supported by the existing pipe 101.

The arcuate plate 2 of the support member 1 is pushed up by the length adjusting members 6 toward the existing pipe 101 so as to move the contact sections 32 of the projections 3 into contact with the inner surface of the existing pipe 101. Hence, the support member 1 can be installed stably on any type of existing pipe 101 and does not fall off.

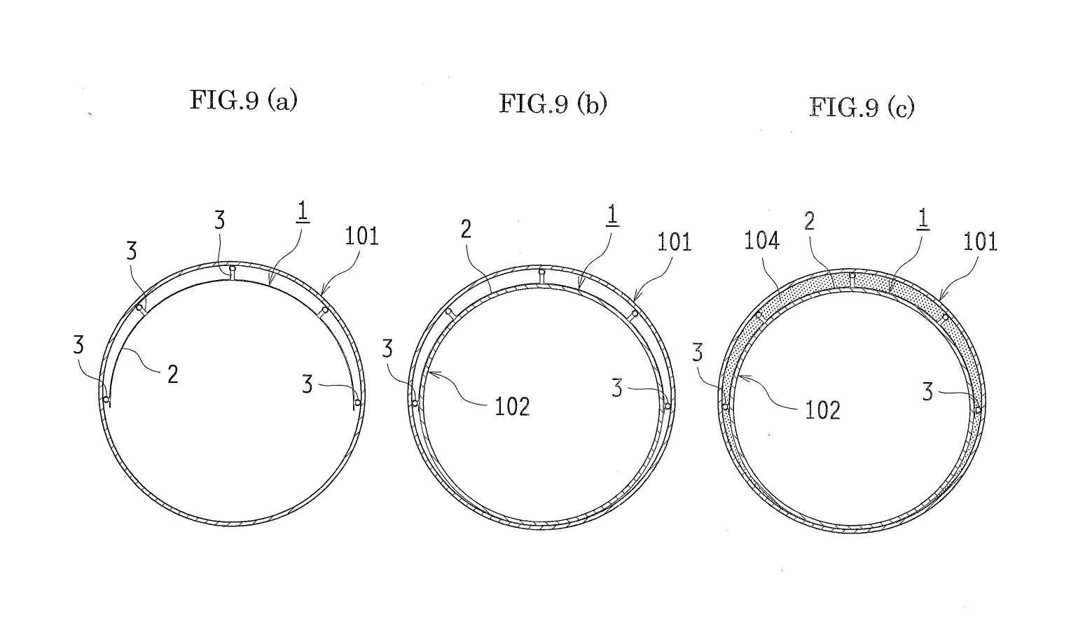

The existing pipe may be rehabilitated in the following manner. Referring to FIG. 9(a), a plurality of support members 1 are installed at specified intervals in the existing pipe 101. Next, the winding machine 105 is assembled in the existing pipe 101 and turned on to form the rehabilitating pipe 102. As illustrated in FIG. 9(b), the outer diameter of the rehabilitating pipe 102 matches the inner diameter of the arcuate plates 2 of the support members 1 installed in the existing pipe 101.

After the rehabilitating pipe 102 is formed along the entire length of the segment of the existing pipe 101 to be rehabilitated, both ends of that segment are closed similarly to embodiment 1. The back-filling material 104 is then injected as illustrated in FIG. 9(c). As the back-filling material 104 cures, the existing pipe 101 and the rehabilitating pipe 102 are integrated, thereby rehabilitating the existing pipe 101.

The injection of the back-filling material 104 produces buoyant force acting on the rehabilitating pipe 102. The buoyant force could lift up the rehabilitating pipe 102. The rehabilitating pipe 102, however, is fixed and hardly lifted because the support members 1 are installed on the outer surface of the rehabilitating pipe 102 so that the support members 1 support the rehabilitating pipe 102 from the approximately three and nine o'clock directions. Besides, the upper half portion of the rehabilitating pipe 102 is in contact with the arcuate plates 2 of the support members 1 along at least half the circumference thereof and hence maintained at a proper distance from the inner surface of the existing pipe 101. The cross-section of the rehabilitating pipe 102 can be thus maintained in a proper, circular shape.

Alternatively, the support members 1 may be installed in the existing pipe 101 without using anchor bolts and related components. According to this configuration, the support members 1 can be installed by a simple process and hence reliably even when the existing pipe 101 is damaged or have a decreased thickness. The support members 1 may be installed simultaneously with the formation of the rehabilitating pipe 102.

### Embodiment 3

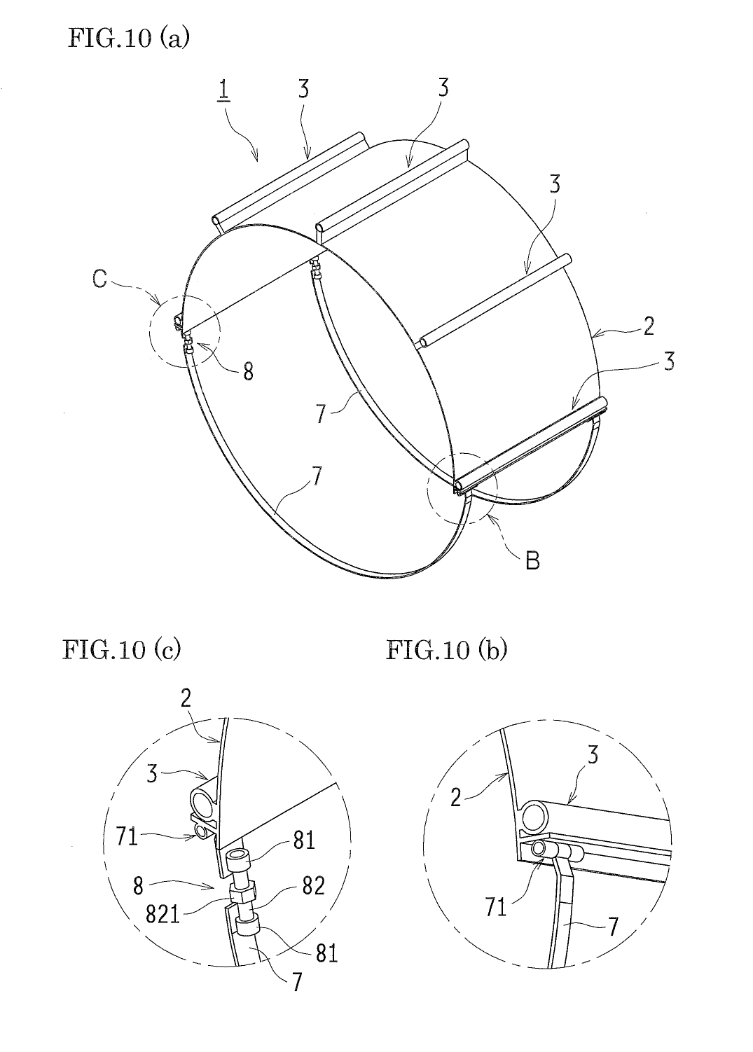

FIGS. 10(a) to 10(c) show a support member 1 in accordance with embodiment 3.

This support member 1 has an outer diameter corresponding to the inner diameter of the existing pipe 101 and includes a plurality of bands 7 each of which has an arc length corresponding to the lower half portion of the existing pipe 101. The bands 7 are disposed in a balanced manner on both side rims of the arcuate plate 2.

Each band 7 has an end thereof coupled freely pivotally to a side rim of the arcuate plate 2 via a hinge 71. At the other end of the band 7 is there provided an adjustment mechanism 8. The adjustment mechanism 8 couples the other end of the band 7 to the side rim of the arcuate plate 2 in such a manner that the arc length of the band 7 is rendered adjustable.

Referring to FIG. 10(c), the adjustment mechanism 8 includes nuts 81 fixed respectively to the arcuate plate 2 and the band 7 and a bolt 82 screwed to both of the nuts 81. Each nut 81 has formed thereon an internal thread that is a reverse thread for the other nut 81. The bolt 82 has an external thread formed at both ends thereof, the external threads being reversed so as to match the reversed internal threads of the nuts 81.

Rotating the bolt 82 in a direction by way of a manual operation portion 821 increases the distance separating the other end of the band 7 from the associated part of the arcuate plate 2. Rotating the bolt 82 in the other direction by way of the manual operation portion 821 decreases that distance.

To attach the support member 1 to the existing pipe 101, the bolt 82 of the adjustment mechanism 8 is manipulated while the contact section 32 of the projection 3 corresponding to the top portion of the existing pipe 101 is in contact with the existing pipe 101. The manipulation enables adjustment of the distance separating the other end of the band 7 from the associated part of the arcuate plate 2. Increasing the arc length of the band 7 moves the band 7 into contact with the inner surface of the lower half portion of the existing pipe 101, thereby pushing up and simultaneously supporting the support member 1. Rotating the bolt 82 pushes up the arcuate plate 2 via the band 7 supported by the inner surface of the lower half portion of the existing pipe 101. In this manner, the projections 3 can be moved into contact with the inner surface of the upper half portion of the existing pipe 101 so that the support member 1 can be installed in the existing pipe 101.

In the current situation, the injection of the back-filling material 104 again produces buoyant force acting on the rehabilitating pipe 102. The rehabilitating pipe 102 is, however, hardly lifted because the support members 1 are installed so that the arcuate plates 2 can support the rehabilitating pipe 102. As a result, the support members 1 maintain the cross-section of the rehabilitating pipe 102 in a proper, circular shape.

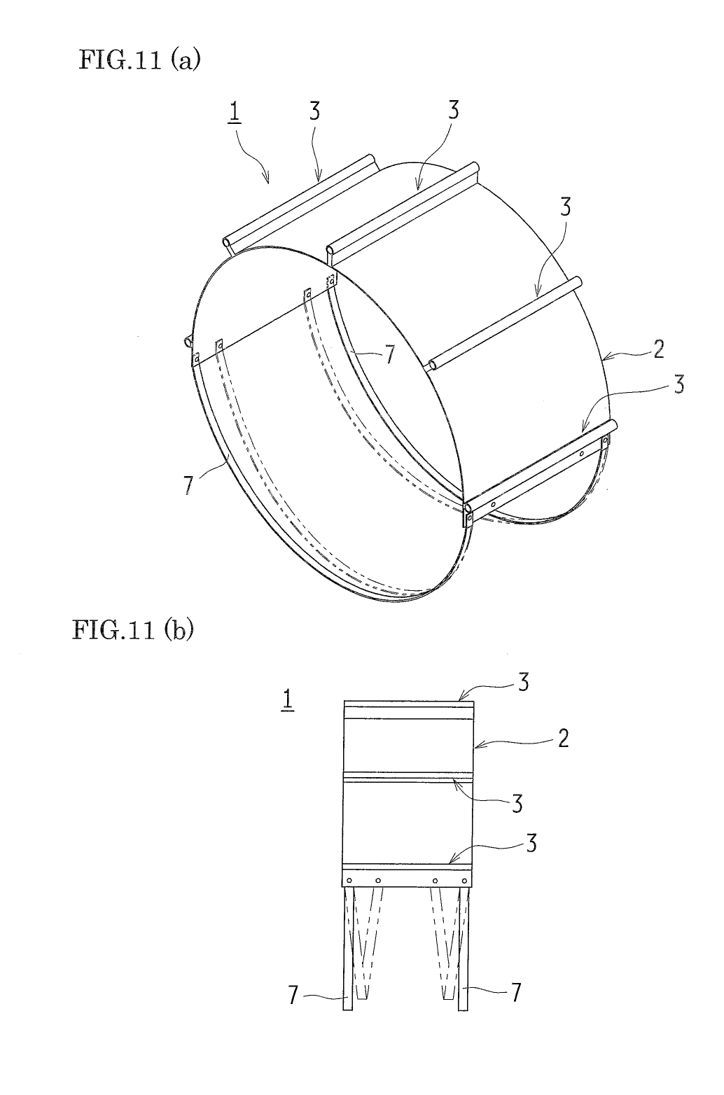

FIGS. 11(a) and 11(b) show a variation example of the support member 1 in accordance with embodiment 3.

In the support member 1, the arc length of the band 7 may be adjusted by any structure other than the adjustment mechanism 8 described above. The arc length of the support member 1 may be rendered adjustable by arranging the bands 7 as illustrated in FIG. 11(a).

Two bands 7 are disposed in a balanced manner on both side rims of an arcuate plate 2 and coupled at both ends thereof as follows. Each band 7 has a first end thereof coupled directly to a side rim of the arcuate plate 2. Referring to FIG. 11(b), the band 7 has the other end thereof coupled at a location that is offset in the axial direction from the coupling site for the first end of the band 7 if the support member 1 is viewed sideways.

When the support member 1 is installed in the existing pipe 101, the arc length of the support member 1 may be adjusted to increase by moving the coupling site for the other end of the band 7, for example, to the location that appears superposed on the coupling site for the first end if the support member 1 is viewed sideways.

Alternatively, the coupling portions at both ends may be pivotally formed without moving the sites where the band 7 is coupled to the side rims of the arcuate plate 2. To install the support member 1 in the existing pipe 101, the support member 1 is moved into the existing pipe 101 after the bands 7 are pivoted and bent relative to the arcuate plate 2. When the support member 1 has reached a predetermined installation site, the bands 7 are pivoted back to its original condition. In addition, the coupling angle may be altered so that the bands 7 can contact the inner surface of the lower half portion of the existing pipe 101. These structures enable easy installation of the support member 1.

### Embodiment 4

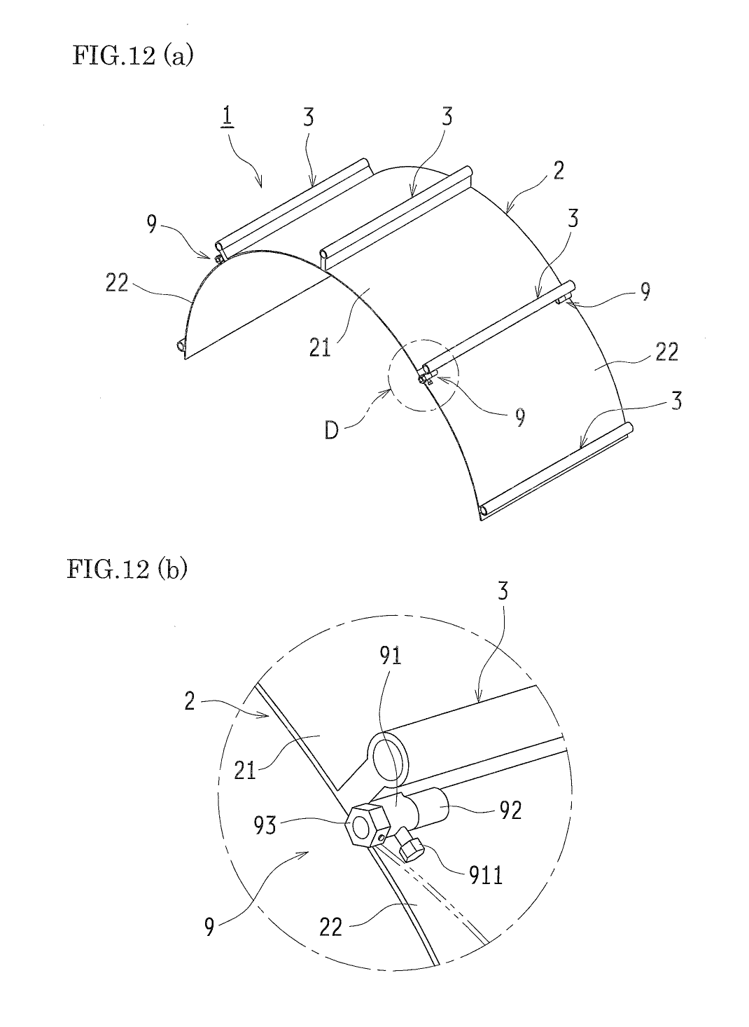

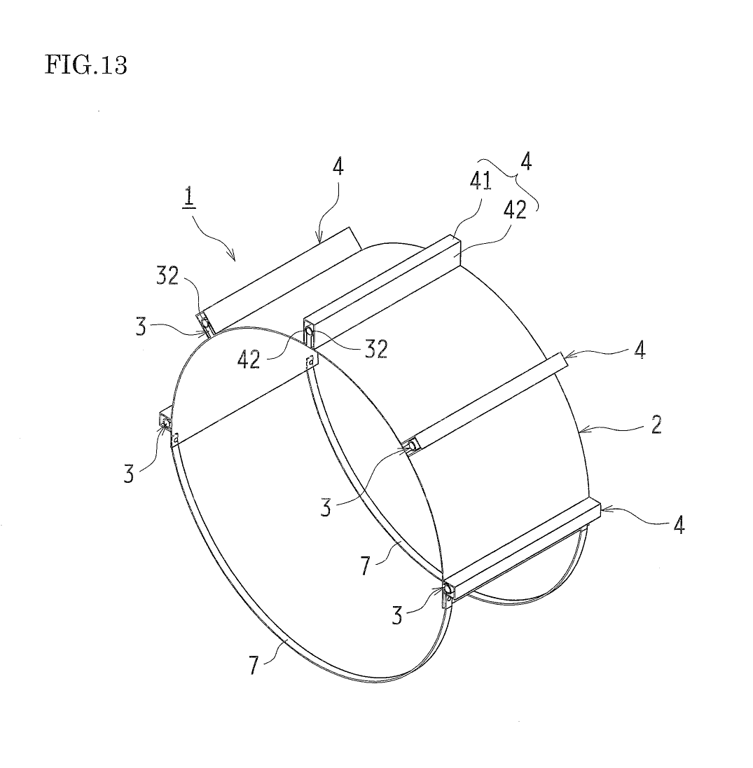

FIGS. 12(a) and 12(b) show a support member 1 in accordance with embodiment 4.

In the support member 1, an arcuate plate 2 is composed of a plurality of members. Namely, the arcuate plate 2 includes a top piece 21 and side pieces 22. The top piece 21 is corresponds to a part of the rehabilitating pipe 102 that contains the top portion thereof. Each side piece 22 is coupled freely pivotally to the top piece 21 via a coupling mechanism 9 and corresponds to a part of the rehabilitating pipe 102 that contains one of the side portions thereof.

By using the coupling mechanisms 9, the side piece 22 can be fixed in any pivotal positions relative to the top piece 21. To the top piece 21, a guide 91 with a securing screw 911 is fixed as illustrated in FIG. 12(b). The side piece 22 includes a pin 92 that can be inserted into the guide 91 on the top piece 21. The pin 92 on the side piece 22 is inserted into the guide 91 on the top piece 21 to fix a retainer 93 to an end of the pin 92. Hence, the side piece 22 is coupled freely pivotally to the top piece 21.

In addition, the side piece 22 is pivoted slightly upward with respect to the top piece 21. The securing screw 911 is tightened up in this condition, with the side piece 22 being held slightly upward. Thus, the pivoting of the pin 92, in other words, the pivoting of the side piece 22, is regulated.

As shown by chain lines in FIG. 12(b), the support member 1 is assembled so that the side pieces 22 are held slightly upward with respect to the top piece 21. Thereafter, the side pieces 22 are elastically deformed and installed on the inner surface of the upper half portion of the existing pipe 101 so that the side pieces 22 have a curvature continuous from the top piece 21. In this structure, the side pieces 22 press the inner surface of the side portions of the existing pipe 101, preventing the support member 1 from falling off and hence enabling the support member 1 to be installed. The top piece 21 and the two side pieces 22 are formed to have an inner diameter that corresponds to the outer diameter of the rehabilitating pipe 102 and to have a continuous radius of curvature, thereby maintaining their distance from the inner surface of the existing pipe 101.

In the current situation, the injection of the back-filling material 104 again produces buoyant force acting on the rehabilitating pipe 102. The rehabilitating pipe 102 is, however, well supported and not lifted because the support members 1 are installed between the inner surface of the existing pipe 101 and the outer surface of the rehabilitating pipe 102. As a result, the rehabilitating pipe 102 is formed with a proper, circular cross-section and sufficient structural integrity to rehabilitate the inner surface of the existing pipe 101.

### Embodiment 5

FIG. 13 shows a support member 1 in accordance with embodiment 5.

After years of use as a sewage pipe, the existing pipe 101 may have a corroded inner surface due to the activity of hydrogen sulfide produced from sewage water. Especially severe corrosion of the existing pipe 101 can occur on the upper half portion (e.g., the top and adjacent portions of the inner surface) thereof, decreasing the thickness of the existing pipe 101. When the existing pipe 101 is to be rehabilitated, it is preferable to cover the inner surface of the existing pipe 101 with a new rehabilitating pipe 102 and simultaneously supplement the decreased thickness of the existing pipe 101.

In the support member 1 shown in FIG. 13, each projection 3 has attached thereto an adjusting member 4 that adjusts a gap between the existing pipe 101 and the rehabilitating pipe 102. The adjusting member 4 is formed by folding a metal strip into the shape of a groove. The adjusting member 4 includes a contact section 41 that contacts the inner surface of the existing pipe 101 and two support sections 42 that support the contact section 41 on the arcuate plate 2. The two support sections 42 are separated by a distance smaller than the outer diameter of the contact section 32 of the projection 3.

The support member 1 includes a plurality of projections 3 to each of which an adjusting member 4 is coupled and fixed. Since the gap separating the two support sections 42 of the adjusting member 4 is narrower than the outer diameter of the contact section 32, the gap is increased when the adjusting member 4 is coupled. This structure causes the support sections 42 to be fixed straddling the projection 3 in contact externally with the contact section 32. Alternatively, the support sections 42 may be fixed tightly to the contact section 32, for example, by way of bolts.

The gap adjusting members 4 are provided in different sizes. The thickness of the existing pipe 101 tends to decrease severely in the upper half portion, especially, in the top portion and its proximities, of the inner surface thereof. The progress of corrosion also varies from site to site along the axis of the existing pipe 101. Accordingly, adjusting members 4 with proper sizes are selected for attachment (fixing) to the projections 3 in accordance with the progress of the corrosion of the inner surface of the existing pipe 101.

The adjusting members 4 given here as an example are of different types in which the support sections 42 come in different widths (the “width” here refers to the distance from the contact section 41 to the outer surface of the arcuate plate 2 to which the adjusting member 4 is attached). For example, the support sections 42 may have different widths of 5 mm, 10 mm, 15 mm, and 20 mm Those adjusting members 4 that have proper sizes to supplement the thickness of the corroded existing pipe 101 are selected from these examples and attached to the projections 3.

Suppose, for example, that the corrosion of the inner surface of the existing pipe 101 is most severe at the top portion (twelve o'clock position) thereof when viewed from the axial direction of the existing pipe 101. Suppose also that the corrosion is, after at the top portion, most severe at the portions adjacent to the top portion (the half-past-one and half-past-ten positions) and that these portions have a decreased thickness. In such a case, an adjusting member 4 with a 20-mm wide support section 42 is attached to the projection 3 at the twelve o'clock position; adjusting members 4 each with a 15-mm wide support section 42 are attached to the projections 3 at the half-past-one and half-past-ten positions; and adjusting members 4 each with a 5-mm wide support section 42 are attached to the projections 3 at the three and nine o'clock positions.

In this manner, the support member 1, instead of being provided directly on the thinner inner surface of the existing pipe 101, is installed in the existing pipe 101 with the adjusting members 4 being attached thereto. In this structure, the adjusting members 4 adjust the gap between the arcuate plate 2 of the support member 1 and the inner surface of the existing pipe 101. The decreased thickness of the existing pipe 101 is supplemented by the sizes of the adjusting members 4 so that the support member 1 can be installed properly to dispose the rehabilitating pipe 102 in a proper position.

Prior to the rehabilitation of the existing pipe 101, the pipe is inspected for corrosion. Based on the results of the inspection, it is determined whether gap adjusting members 4 need to be fitted to the support members 1 to be installed. Proper adjusting members 4 are then selected in accordance with the progress of corrosion in the existing pipe 101. The support members 1 are then installed, and the rehabilitating pipe 102 formed, along the entire length of the segment of the existing pipe 101 to be rehabilitated. That is followed by the injection of the back-filling material 104 similarly to the previous cases. As the back-filling material 104 cures, the rehabilitating pipe 102 and the existing pipe 101 are integrated, thereby rehabilitating the existing pipe 101. Besides, those parts of the existing pipe 101 where the thickness thereof has decreased are supplemented with the back-filling material 104. The existing pipe 101 is hence uniformly rehabilitated. The injection of the back-filling material 104 produces buoyant force acting on the rehabilitating pipe 102. However, the support members 1 installed on the outer surface of the rehabilitating pipe 102 prevent the rehabilitating pipe 102 from being lifted, thereby maintaining the cross-section of the rehabilitating pipe 102 in a proper, circular shape.

If the inner surface of the existing pipe 101 is corroded, the decreased thickness of the existing pipe 101 can be supplemented by using these support members 1. The rehabilitating pipe 102 can be formed continuously without having to alter the diameter of the rehabilitating pipe 102 along the entire length of the segment to be rehabilitated. The rehabilitation work can be completed quickly and efficiently.

As described in the foregoing, according to the method of rehabilitating an existing pipe and the support member 1 for a rehabilitating pipe both in accordance with the present invention, quick and efficient rehabilitation work can be performed on any existing pipe 101, and the construction period for the whole project is greatly shortened.

In addition, the support member 1 supports the rehabilitating pipe 102 by flanking on the right and left parts of the outer surface thereof when viewed from the axial direction of the rehabilitating pipe 102 and squeezing at least from the approximately three and nine o'clock directions. The rehabilitating pipe 102 is hence effectively prevented from being lifted or deformed by the buoyant force acting on the rehabilitating pipe 102, thereby maintaining a proper cross-sectional shape thereof. That in turn imparts sufficient structural integrity and drain capability to the rehabilitated pipe line. Furthermore, the support member 1 can be installed quickly and efficiently in the existing pipe 101 by an extremely simple process as mentioned earlier and does not require removal and other post-processing, which greatly shortens the construction period.

The embodiments above described the projections 3 being disposed substantially at the three, half-past-one, twelve, half-past-ten, and nine o'clock positions on the arcuate plate 2 of the support member 1 as an example. The present invention is by no means limited to this arrangement. The projections 3 may be disposed at various positions in consideration of the diameter of the rehabilitating pipe 102 and other conditions. If the arcuate plate 2 of the support member 1 already has projections 3 at least on the right- and left-hand sides when viewed from the axial direction, no projections 3 may need to be provided at other positions. The components of the support member 1 may be made of any material other than steel, iron, and other metals, so long as the material has necessary structural integrity.

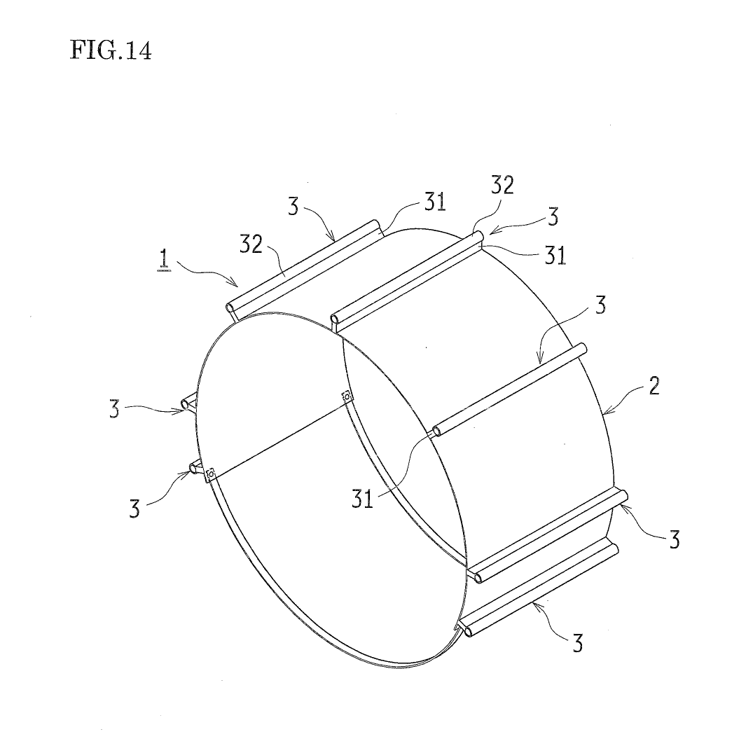

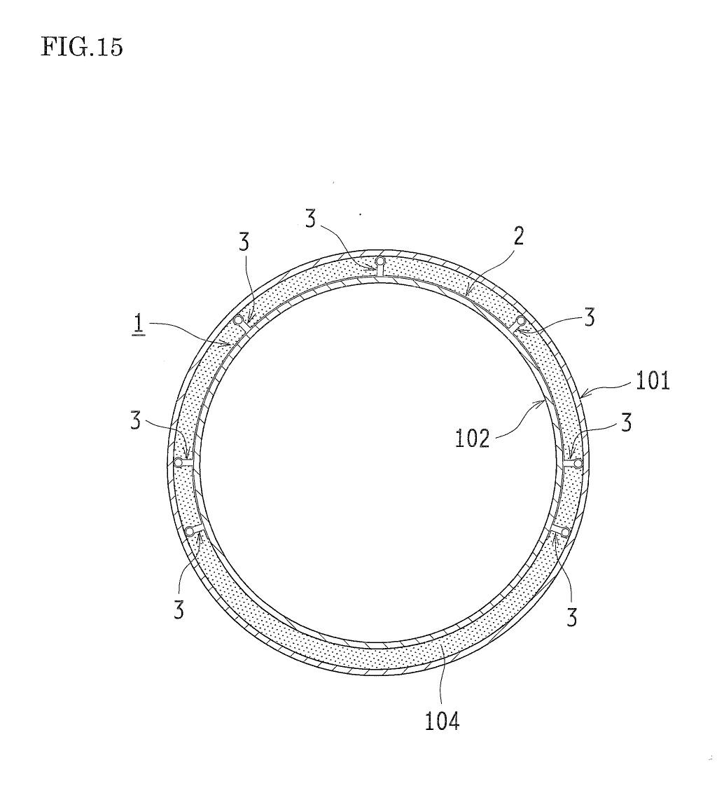

For example, the support member 1 may be formed as illustrated in FIG. 14 or 15, in which case the support member 1 may be used, for example, at a site where the existing pipe 101 changes the slope thereof. In these support members 1, the arcuate plate 2 is formed to have an arc length greater than that of the arcuate plate 2 of embodiment 1. The arcuate plate 2 is formed to have downward extensions at both the distal ends thereof in a right/left symmetric manner as viewed from the axial direction, the extensions substantially reaching the four and eight o'clock positions. The projections 3 are all formed to have the same height.

At sites where the existing pipe 101 changes the slope thereof, the rehabilitating pipe 102 needs to be formed continuously from the upstream to the downstream side thereof without being deformed. In such a case, the support member 1 shown in FIG. 14 is installed where the slope is changed. The rehabilitating pipe 102 is formed in contact internally with the arcuate plate 2 of the support member 1 while being lifted up from the bottom portion of the existing pipe 101. This structure accommodates changing slope by enabling the rehabilitating pipe 102 to be formed with a gentle slope without causing excessive deformation of the existing pipe 101 at the site where the existing pipe 101 changes the slope thereof. After the rehabilitating pipe 102 is formed, the back-filling material 104 is injected as illustrated in FIG. 15. In this manner, the existing pipe 101 can be rehabilitated even at the site where the slope is changed, with the cross-section of the rehabilitating pipe 102 being maintained in a proper, circular shape.

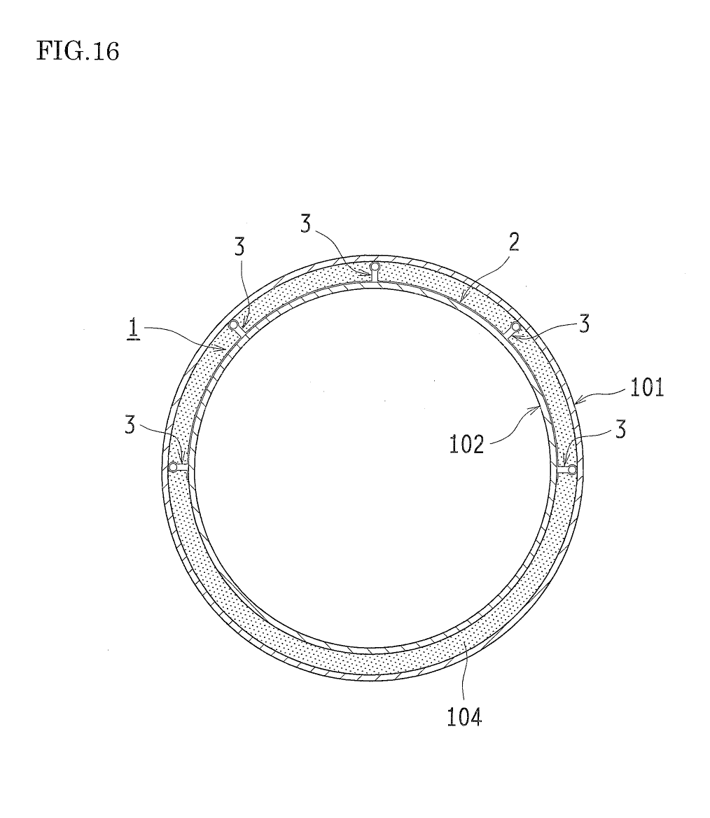

The rehabilitating pipe 102 may be formed by installing the support member 1 shown in FIG. 16 at a site where the existing pipe 101 changes the slope thereof. When this is the case, in the support member 1, the arcuate plate 2 is formed with a substantially semicircular cross-section, and the projections 3 are all formed to have the same height. The support member 1 is installed on the upper half portion of the inner surface of the existing pipe 101 at the site where the existing pipe 101 changes the slope thereof. Although the rehabilitating pipe 102 is formed in contact with the bottom portion of the existing pipe 101, the injection of the back-filling material 104 lifts up the rehabilitating pipe 102, moving the rehabilitating pipe 102 into contact internally with the arcuate plate 2, at that site. In this manner, the existing pipe 101 can be rehabilitated even at the site where the slope is changed, with the cross-section of the rehabilitating pipe 102 being maintained in a proper, circular shape, similarly to the example in FIG. 15.

The embodiments above described rehabilitation methods implemented with the bottom portion of the rehabilitating pipe 102 being in contact with the bottom portion of the existing pipe 101. The present invention is by no means limited to this mode. Alternatively, for example, the rehabilitating pipe 102 may be supported in such a position that the bottom portion of the rehabilitating pipe 102 is elevated to a specified height above the bottom portion of the existing pipe 101, by adjusting the length of the radial ribs 31 of the support member 1. Alternatively, the rehabilitating pipe 102 may be supported in such a position that the axial center of the rehabilitating pipe 102 matches the axial center of the existing pipe 101. Even in these cases, the rehabilitating pipe 102 is supported using the support member 1 as in the previous cases; therefore, the cross-section of the rehabilitating pipe 102 is maintained in a proper, circular shape, and efficient rehabilitation work is performed on the existing pipe.

If a plurality of support members 1 are provided at intervals, the back-filling material 104 reaches spaces between the ribs of the spirally wound profile strip 103, filling the spaces unfailingly. For example, the arcuate plate 2 may be provided with numerous holes or made of a punching metal or another like porous plate, so as to ensure that the back-filling material 104 is injected into spaces between the ribs of the profile strip 103. The winding machine that forms the rehabilitating pipe is by no means limited to the winding machine 105 illustrated as an example in FIG. 17; the winding machine may be constructed in any manner so long as the machine spirally wind the elongate profile strip 103 and guides a side edge of the profile strip 103 internally relative to a preceding side edge of the profile strip 103 to join the side edges together.

The present invention may be implemented in various forms without departing from its spirit and main features. Therefore, the aforementioned examples are for illustrative purposes only in every respect and should not be subjected to any restrictive interpretations. The scope of the present invention is defined only by the claims and never bound by the specification. Those modifications and variations that may lead to equivalents of claimed elements are all included within the scope of the invention.

The present application hereby claims priority on Japanese Patent Application, Tokugan, No. 2013-123898 filed Jun. 12, 2013 in Japan, the entire contents of which are hereby incorporated herein by reference.

### INDUSTRIAL APPLICABILITY

The present invention is preferably employed to rehabilitate old existing pipes efficiently in a short time.

### REFERENCE SIGNS LIST

1 Support Member
2 Arcuate Plate
3 Projection
31 Radial Rib
32 Contact Section
4 Gap Adjusting Member
6 Length Adjusting Member
7 Band
8 Adjustment Mechanism
9 Coupling Mechanism
101 Existing Pipe
102 Rehabilitating Pipe
103 Profile Strip
104 Back-filling Material
105 Winding Machine

1. A method of rehabilitating an existing pipe by forming a rehabilitating pipe in the existing pipe, said method comprising the steps of:
installing a plurality of support members in the existing pipe, each of the plurality of support members including an arcuate plate that has an inner diameter corresponding to an outer diameter of the rehabilitating pipe;
disposing the arcuate plates at least on an upper half portion of an inner surface of the existing pipe to fix the plurality of support members;
spirally winding an elongate profile strip and guiding a side edge of the profile strip internally relative to a preceding side edge of the profile strip so as to form the rehabilitating pipe in contact internally with the arcuate plates by joining the side edges together; and
causing the arcuate plates to support at least right and left parts of an outer surface of the rehabilitating pipe as viewed from an axial direction of the rehabilitating pipe and filling a gap between the rehabilitating pipe and the existing pipe with a back-filling material.

2. The method as set forth in claim 1, wherein the plurality of support members are installed along an axis of the existing pipe at specified intervals.

3. The method as set forth in claim 1, the plurality of support members are installed in the existing pipe prior to the rehabilitating pipe being formed.

4. The method as set forth in claim 1, wherein the back-filling material is injected, and cured in phases, first in a lower part, then in a middle part, and subsequently in an upper part of the gap between the rehabilitating pipe and the existing pipe.

5. A support member for a rehabilitating pipe, comprising:
an arcuate plate that has an inner diameter corresponding to an outer diameter of the rehabilitating pipe and an arc length greater than or equal to half an outer circumference of the rehabilitating pipe; and
a. plurality of projections provided on an outer surface of the arcuate plate and extending in an axial direction,
wherein:
the plurality of projections are disposed at least on right- and left-hand sides when viewed from the axial direction and at intervals that are measured along the arc length of the arcuate plate;
the rehabilitating pipe is formed in an existing pipe by spirally winding an elongate profile strip and joining a side edge of the profile strip internally to a preceding side edge of the profile strip; and
the arcuate plate is fixed internally to an upper portion of the existing pipe and supports the rehabilitating pipe in such a manner as to maintain an inner surface of the existing pipe at a fixed distance from an outer surface of the rehabilitating pipe.

6. The support member as set forth in claim 5, wherein each of the plurality of projections includes: a radial rib that defines the fixed distance; and a contact section provided on a distal end of the radial rib in contact with the inner surface of the existing pipe.

7. The support member as set forth in claim 5, wherein the plurality of projections are separable from the arcuate plate so that the support member can be assembled by coupling a required number of projections to the arcuate plate.

8. The support member as set forth in claim 5, wherein each of the plurality of projections has an adjusting member that adjusts a gap between the inner surface of the existing pipe and the outer surface of the arcuate plate.

9. The support member as set forth in claim 5, wherein the arcuate plate includes an adjusting member, provided on a side rim thereof, that adjusts an arc length of the support member.

10. The support member as set forth in claim 5, wherein the support member has an outer diameter corresponding to an inner diameter of the existing pipe and includes a band that has an arc length equal to that of a lower half portion of the existing pipe, the band being coupled to a side rim of the arcuate plate so as to render the arc length of the band adjustable.

11. The support member as set forth in claim 5, wherein the arcuate plate is composed of multiple pieces, one corresponding to a top portion of the rehabilitating pipe and others corresponding to side portions of the rehabilitating pipe, the piece corresponding to the side portions being coupled freely pivotally to the piece corresponding to the top portion and so as to be capable of being fixed in any pivotal position.

12. The method as set forth in claim 2, wherein the back-filling material is injected and cured in phases, first in a lower part, then in a middle part, and subsequently in an upper part of the gap between the rehabilitating pipe and the existing pipe.

13. The method as set forth in claim 3, wherein the back-filling material is injected and cured in phases, first in a lower part, then in a middle part, and subsequently in an upper part of the gap between the rehabilitating pipe and the existing pipe.

14. The support member as set forth in claim 6, wherein the arcuate plate includes an adjusting member, provided on a side rim thereof, that adjusts an arc length of the support member.

15. The support member as set forth in claim 7, wherein the arcuate plate includes an adjusting member, provided on a side rim thereof, that adjusts an arc length of the support member.

16. The support member as set forth in claim 8, wherein the arcuate plate includes an adjusting member, provided on a side rim thereof, that adjusts an arc length of the support member.

17. The support member as set forth in claim 6, wherein the support member has an outer diameter corresponding to an inner diameter of the existing pipe and includes a band that has an are length equal to that of a lower half portion of the existing pipe, the band being coupled to a side rim of the arcuate plate so as to render the arc length of the band adjustable.

18. The support member as set forth in claim 7, wherein the support member has an outer diameter corresponding to an inner diameter of the existing pipe and includes a band that has an are length equal to that of a lower half portion of the existing pipe, the band being coupled to a side rim of the arcuate plate so as to render the arc length of the band adjustable.

19. The support member as set forth in claim 8, wherein the support member has an outer diameter corresponding to an inner diameter of the existing pipe and includes a band that has an arc length equal to that of a lower half portion of the existing pipe, the band being coupled to a side rim of the arcuate plate so as to render the arc length of the band adjustable.

20. The support member as set forth in claim 6, wherein the arcuate plate is composed of multiple pieces; one corresponding to a top portion of the rehabilitating pipe and others corresponding to side portions of the rehabilitating pipe, the piece corresponding to the side portions being coupled freely pivotally to the piece corresponding to the top portion and so as to be capable of being fixed in any pivotal position.

21. The support member as set forth in claim 7, wherein the arcuate plate is composed of multiple pieces, one corresponding to a top portion of the rehabilitating pipe and others corresponding to side portions of the rehabilitating pipe, the piece corresponding to the side portions being coupled freely pivotally to the piece corresponding to the top portion and so as to be capable of being fixed in any pivotal position.

22. The support member as set forth in claim 8, wherein the arcuate plate is composed of multiple pieces, one corresponding to a top portion of the rehabilitating pipe and others corresponding to side portions of the rehabilitating pipe, the piece corresponding to the side portions being coupled freely pivotally to the piece corresponding to the top portion and so as to be capable of being fixed in any pivotal position.
